(19) United States
(12) Patent Application Publication
(10) Pub. No.: US 2009/0018043 A1
(43) Pub. Date: Jan. 15, 2009

(54) PROCESS FOR MAKING A TABLET

(76) Inventors: Petra Beckers, Oststeinbek (DE); Reinhard Steiger, Ladenburg (DE); Ralf Wiedemann, Ludwigshaften (DE)

Correspondence Address: NORRIS, MCLAUGHLIN & MARCUS, 875 THIRD AVE, 18TH FLOOR, NEW YORK, NY, 10022, US

(21) Appl. No.: 11/718,491

(22) PCT Filed: Oct. 24, 2005
(86) PCT No.: PCT/GB05/04091

§ 371 Date: May 23, 2008

(30) Foreign Application Priority Data
Nov. 3, 2004 (GB) 0424323.4

(51) Int. Cl. C11D 17/00

(52) U.S. Cl. 510/224; 510/446

(57) ABSTRACT

A process for making a tablet having at least three layers, the process comprises:
a) addition of a first composition into a mould of a tabletting press;
b) addition of a second composition into the mould of the tabletting press;
c) compression of the first two compositions with a piston, said piston having a projection on its compressing surface;
d) addition of a third composition into the mould of the tabletting press;
e) compression of the third composition with the piston, and
f) optionally adding a further composition into the recess of the tablet.

The invention relates to a method of producing a tablet, in particular a detergent tablet, having at least three layers.

In applications involving washing agents and detergents, tablets have established a place for themselves on the market in recent years as a format that provides easy metering and is simple to use.

Multi-layer tablets (e.g. two-layer tablets) are commonplace. In these tablets commonly different ingredients are divided between the two layers, first as a means of separating substances that are not compatible with one another until the tablet is used, and second as a means of producing different release profiles for the substances contained in them.

The tablets are generally produced in presses which are similar to those used for single-layer tablets, although some modifications have to be made. In the case of a two-layer tablet, a first mixture with a first composition is usually poured into a mould and subjected to a preliminary compacting process at a first pressure. Then, a second mixture having a second, different composition is poured into the mould on top of the first, pre-compacted layer, followed by a final compaction process at a second, usually higher pressure.

A problem which is experienced with multi-layer tablets, formed in a compression process, is that of achieving a joint between the individual layers which is stable enough to prevent the layers coming apart during storage and transportation but which is not so strong as to overly inhibit the dissolution time of the tablet in a washing medium, particularly in an automatic washing machine.

This problem is exacerbated when the tablet has three or more layers. If each of the tablet layers is compressed in normal tablet forming techniques, then normally the tablet is overly compressed and so displays an overly long dissolution time.

A further problem with tablets having three or more layers is the attainment of a cavity in a layer of the tablet. (Such a cavity may be required to accept a portion of the tablet (e.g. in the form of a pre-compressed pellet); the pellet being added for purely aesthetic reasons or pellet containing a component which needs to be kept separate from the remainder of the tablet layers).

The main ground for this problem is connected with the size constraints on the dimensions of the tablet. For example the tablet accepting chambers of many automatic washing machines, particularly automatic dishwashing machines have a limited and standard size. Thus the tablet has to be sized within these dimensions in order to be accepted into the chamber.

For an automatic dishwasher typically the height dimension of the tablet is around 17 mm in order to fit into such a chamber. It is difficult to compress a three layer tablet having this height dimension wherein the tablet comprises a cavity having a dimension of, for example 11 mm.

The presence of the cavity is usually achieved by altering a tablet compression piston so that the piston face is not simply planar but has a projection (more commonly referred to as a pin) thereon. In this way a cavity, which is largely complementary to the piston is created in an upper face of the compressed tablet.

If a standard tablet piston having a fixed pin is used there is a problem of how to achieve a sizeable cavity in the tablet whilst producing tablets having acceptable stability and aesthetic appeal. This problem is particularly prevalent in multi-layer tablets having three or more layers since each layer only makes up a small portion of the overall height of the tablet. Thus in cases where the individual layers are compressed successively, using a piston with a fixed pin, due to the relative low thickness of the layers there is a high risk that in the compression of the initial layers the pin of the piston will contact the compression base of the press.

This has the implication that the initial layers of the tablet have had to be relative thick, compared to the total width of the tablet so that the pin can be accommodated.

In an alternative solution all of the layers of the multi-layer tablet can be added to the tabletting press before compression so that the plurality of layers can be compressed using a piston having a fixed pin. However, whilst this solution overcomes the pin contact issue, tablets produced in this way commonly display a poor distinction between the layers leading to poor overall tablet aestethics and low consumer appeal.

One way to solve the issues above is to use an upper piston having a moveable pin. In this way the pin can be retracted when comprising the initial layers of the tablet, to avoid contact with the compression base and then extended when the depth of material to be compressed is sufficient.

However, pistons having moveable pins have their own associated disadvantages. Due to the higher level of complexity of the piston the initial purchase is higher. Also, despite various preventative measures, there is still a significant problem of piston abrasion caused, particular when compressing particulate materials, due to ingress of particulate material between the movable parts of the piston.

It is an object of the present invention to obviate/mitigate the problems outlined above.

According to the present invention there is provided a process for making a tablet having at least three layers, the process comprising:

a) addition of a first composition into a mould of a tabletting press;
b) addition of a second composition into the mould of the tabletting press;
c) compression of the first two compositions with a piston, said piston having a projection on its compressing surface;
d) addition of a third composition into the mould of the tabletting press;
e) compression of the third composition with the piston, and
f) optionally adding a further composition into the recess of the tablet.

Most preferably the second and/or third composition are added into recesses created into the mould. Generally said recesses are created by moving a lower piston associated with the mould in order to create a vacant volume within the mould, which can accept the incoming material. The vacant volume forming steps may be present as steps a)ii) and/or c)ii).

It will be appreciated that the method of the invention is not limited to three layer tablets: steps (d) and/or (e) may be repeated to obtain a tablet having more than three layers.

The method of the present invention has been found to be particularly advantageous when compared to multi-layer tabletting methods of the prior art. A principle advantage is that the method of the present invention permits the formation of multiple layer tablets, the tablets having three layers or more, with the use of a compression piston having a fixed pin, without incurring any compression contact problems of the pin.

As the method of the present invention allows the production of multi-layer tablets including a cavity without the need for a piston having a movable pin the overall manufacturing process is cheaper as there is no need for a complex piston nor is there any need for the additional maintenance that such a piston requires.

As multi-layer tablets may be produced with a reduced number of compression steps (compared to the number of layers) the wear and operating costs associated with the compression stages of the tablet are considerable reduced. This also has the effect that the tablets are not overly compressed and so the tablets display remarkable rapid dissolution times without the need for a higher level of tablet disinstegrants.

Furthermore tablets produced in this method have been found to have excellent stability and aesthetic qualities. The tablets produced in accordance show excellent distinction between layers, yet due to the compression piston having a projection on the compression surface there is exceptional bonding between the layers.

The size of the recess may be altered to suit the requirements of the composition which is to be accommodated by the recess whilst ensuring that the recess is not overly deep such that the integrity of the tablet is threatened. Generally the depth of the recess may be up to 65% of the overall height of the tablet.

It will be appreciated that the compression pressure in step (c) may differ from the compression pressure in step (e). Indeed it has been found that the compression pressure in step (c) should be lower than in step (e). This is general practise for tablets formed in multi-compression steps. Generally the compression pressure in step (c) is around 200 kg/cm². Generally the compression pressure in step (e) is around 700-900 kg/cm².

The compositions of each of the layers is preferably particulate in nature. Most preferably the particulates have a particle size of between 100 to 2000 μm, with between 600 to 1000 μm being most preferred.

The relative dimensions of the layers can be altered to suit the performance requirements of the tablet alone, possibly together in conjunction with the aesthetic requirements for the tablet. Generally the layers a-resized such that each layer comprises at least 20% of the overall volume (and hence usually the height) of the tablet. Usually the layers each comprises around 30-40% of the volume of the tablet. Most preferably the size of the first two layers is such that the pin of the press can be accommodated without difficulty, therefore it is preferred that the first and second layers, when compressed, make up at least the same percentage height of the tablet as the height of the pin relative to the overall height of the tablet.

The composition which is optionally present in the recess in an upper face of the tablet may comprise a pre-formed shape or may be added in a fluid form (e.g. as a flowing particulate or liquid). Where a fluid form is employed the fluid form is hardened or compressed (as suitable) for integrity/retention in the recess. Where the compression in the recess is compressed/hardened in situ there may be no need for an additional adhesive to retain the recess composition. Where the recess composition comprises a pre-formed shape (formed by, for example, compression or injection moulding) an adhesive may be required.

The tablets are preferably for use in a domestic cleaning process, most particularly in an automatic washing or dishwashing operation. Therefore it is preferred that each layer composition comprises typical detergent components such as builder, surfactant, binder, enzyme, bleach, bleach catalysts, bleach activator, pH modifying agent, dye, preservative, optical brightener, perfume. In these uses the adhesive, where present, for the pre-formed shape, is preferably suitable for dispersion in an automatic washing machine. Preferred example such adhesives include sorbitol and PEG (e.g. PEG 6000).

It will be appreciated that there is some flexibility of arrangement of each of the individual components between the layers of the tablet. It will also be appreciated that certain antagonistic components, such as bleach and enzyme, should not be placed in the same layer of the tablet. Also where individual layers of the tablet have been modified to dissolve at certain rates it may be necessary to add certain components to those layers. For example, for an automatic dishwashing tablet, where a layer has been modified to dissolve slowly to release a component into a rinse cycle it may be appropriate to add the rinse aid to that layer.

The recess composition is preferably a detergent composition. The recess composition may be selected due to its incompatibility with the composition of the other layers or due to the special dissolution/release profile of the composition in the recess.

The invention will now be illustrated further by reference to the following non-limiting Examples.

### EXAMPLE 1

### Automatic Dishwashing Tablet A

A 3-layer tablet having a cavity in the top layer is manufactured by filling material for the first and second layers, pre-compressing the two layers at less than 200 kg/cm², filling a third layer followed by a final compression of 700-800 kg/cm².

The dimensions of the tablet were length 36 mm; width: 26 mm; height 17 mm; weight 23.0 g.

Formulation for a 3-Layer Dishwashing Tablet:

| | Total | Layer #1 | Layer #2 | Layer #3 |
|---|---|---|---|---|
| Component | (wt %) | (33.3%) | (33.3%) | (33.3%) |
| Sodium perborate | 11.0 | — | 33.0 | — |
| Sodium tripolyphosphate | 62.8 | 80.0 | 48.8 | — |
| Sodium bicarbonate | 1.2 | 3.0 | — | — |
| Sodium carbonate | 9.6 | 7.4 | 7.7 | 69.0 |
| Polyethyleneglycol | 4.2 | 7.5 | 1.0 | 0.8 |
| Phosphonate | 0.2 | 0.3 | — | 13.6 |
| Homopolymer PAA | 1.0 | — | — | 4.0 |
| TAED | 3.0 | — | — | 3.0 |
| Amylase | 0.5 | — | — | 1.5 |
| Protease | 0.8 | — | — | 2.3 |
| Dye | 0.05 | 0.12 | — | 0.03 |
| Corrosion inhibitor (Ag) | 0.3 | 0.42 | 0.42 | — |
| Nonionic | 4.5 | — | 8.5 | 5.0 |
| Mg Stearate | 0.1 | 0.3 | — | — |
| Antifoam | 0.1 | — | — | 0.31 |
| Glycerol | 0.6 | 0.9 | 0.6 | 0.4 |
| Fragrance | 0.04 | 0.11 | — | — |
| | 100.00 | 100.00 | 100.00 | 100.00 |

A pill is manufactured by casting the formula into a spherical mould at 100° C. and allowing it to chill (diameter 11.0 mm; weight 0.8 g). The pill is then coated in a film coater with polyvinyl alcohol.

| Component | Wt % |
|---|---|
| Nonionic surfactant | 45.0 |
| Polyethyleneglycol (35000) | 53.0 |
| Polyvinyl alcohol | 2.0 |
| | 100.0 |

The pill is added to the cavity and adhered thereto by means of an adhesive (either molten sorbitol or molten PEG 6000).

### EXAMPLE 2

### Automatic Dishwashing Tablet B

A 3-layer tablet is manufactured as described in Example 1.

Formulation for a 3-Layer Dishwashing Tablet:

| | Total | Layer #1 | Layer #2 | Layer #3 |
|---|---|---|---|---|
| Component | (wt %) | (33.3%) | (33.3%) | (33.3%) |
| Sodium perborate | 11.0 | — | 33.0 | — |
| Sodium tripolyphosphate | 66.0 | 80.3 | 48.8 | 69.0 |
| Sodium bicarbonate | 1.2 | 3.0 | — | 0.8 |
| Sodium carbonate | 9.6 | 7.4 | 7.7 | 13.6 |
| Polyethyleneglycol | 4.2 | 7.5 | 1.0 | 4.0 |
| Homopolymer PAA | 1.0 | — | — | 3.0 |
| Amylase | 0.5 | — | — | 1.5 |
| Protease | 0.8 | — | — | 2.3 |
| Dye | 0.05 | 0.12 | — | 0.03 |
| Corrosion inhibitor (Ag) | 0.3 | 0.42 | 0.42 | — |
| Nonionic | 4.5 | — | 8.5 | 5.0 |
| Mg Stearate | 0.1 | 0.3 | — | — |
| Antifoam | 0.1 | — | — | 0.31 |
| Glycerol | 0.6 | 0.9 | 0.6 | 0.4 |
| Fragrance | 0.04 | 0.11 | — | — |
| | 100.00 | 100.00 | 100.00 | 100.00 |

A pill is manufactured by compressing the below formula with a compression of 1500 kg/cm² (diameter 15.0 mm; height 8 mm; weight 2.4 g).

| Component | Wt % |
|---|---|
| Lactose | 28.0 |
| Microcrystalline cellulose | 10.5 |
| Polyvinylpyrolidone | 2.0 |
| Phosphonate | 6.0 |
| TAED | 52.5 |
| Mg-stearate | 0.5 |
| dye | 0.5 |
| | 100.0 |

The pill is added to the cavity and adhered thereto by means of an adhesive (either molten sorbitol or molten PEG 6000).

### EXAMPLE 3

### Automatic Dishwashing Tablet C

A 3-layer tablet is manufactured as described in Example 1.

Formulation for a 3-layer dishwashing tablet:

| | Total | Layer #1 | Layer #2 | Layer #3 |
|---|---|---|---|---|
| Component | (wt %) | (33.3%) | (33.3%) | (33.3%) |
| Sodium perborate | 11.0 | — | 33.0 | — |
| Sodium tripolyphosphate | 63.5 | 80.0 | 48.5 | 62.3 |
| Sodium bicarbonate | 1.2 | 3.0 | — | 0.8 |
| Sodium carbonate | 9.6 | 7.4 | 7.7 | 13.6 |
| Polyethyleneglycol | 4.2 | 7.5 | 1.0 | 4.0 |
| Phosphonate | 0.2 | 0.3 | 0.3 | |
| Homopolymer PAA | 1.0 | — | — | 3.0 |
| TAED | 3.0 | — | | 9.0 |
| Amylase | 0.5 | — | — | 1.5 |
| Dye | 0.05 | 0.12 | — | 0.03 |
| Corrosion inhibitor (Ag) | 0.3 | 0.42 | 0.42 | — |
| Nonionic | 4.5 | — | 8.5 | 5.0 |
| Mg Stearate | 0.1 | 0.3 | — | — |
| Antifoam | 0.1 | — | — | 0.31 |
| Glycerol | 0.6 | 0.9 | 0.6 | 0.4 |
| Fragrance | 0.04 | 0.11 | — | — |
| | 100.00 | 100.00 | 100.00 | 100.00 |

A pill is manufactured by compressing the below formula with a compression of 1200 kg/cm² (diameter 13.0 mm; height 8 mm; weight 1.4 g).

| Component | Wt % |
|---|---|
| Lactose | 20.0 |
| Microcrystaline cellulose | 18.0 |
| Sodium bicarbonate | 30.0 |
| Citric Acid | 15.0 |
| Protease | 10.0 |
| Phosphonate | 2.0 |
| Polyethyleneglycol | 4.0 |
| Mg Stearate | 0.5 |
| dye | 0.5 |
| | 100.0 |

The pill is added to the cavity and adhered thereto by means of an adhesive (either molten sorbitol or molten PEG 6000).

### EXAMPLE 4

### Automatic Laundry Tablet C

A 3-layer tablet is manufactured as described in Example 1.

Formulation for a 3-Layer Laundry Tablet:

| | Total | Layer #1 | Layer #2 | Layer #3 |
|---|---|---|---|---|
| Component | (wt %) | (33.3%) | (33.3%) | (33.3%) |
| LAS | 12.6 | 12.5 | 13.0 | 12.5 |
| Soap | 1.2 | 1.25 | 1.2 | 1.25 |
| Alkylsulphate | 2.3 | 2.0 | 3.5 | 2.0 |
| Phosphonate | 0.6 | 0.5 | 1.0 | 0.5 |
| Polymer | 2.3 | 2.3 | 2.3 | 2.3 |
| Zeolite | 5.7 | 5.5 | 6.5 | 5.5 |
| Sodium Carbonate | 19.1 | 19.0 | 19.7 | 19.0 |
| Sodium Carbonate-CMC | 0.3 | 0.3 | 0.3 | 0.3 |
| Sodium Sulphate | 3.0 | 3.0 | 2.7 | 3.0 |
| Sodium Silicate | 1.9 | 2.0 | 1.0 | 2.0 |
| Amorphous Silicate | 8.8 | 8.0 | 13.0 | 8.0 |
| Antifoam | 0.5 | 0.5 | 0.3 | 0.5 |
| Disintegrant | 10.0 | 10.0 | 10.0 | 10.0 |
| Polyethyleneglycol | 0.15 | — | 1.0 | — |
| Dye | 0.003 | — | 0.1 | — |
| Amylase | 0.3 | — | 1.7 | — |
| Sodium Percarbonate | 25.6 | 30.0 | — | 30.0 |
| TAED | 2.7 | — | 9.0 | — |
| Optical Brightener | 0.3 | 0.3 | 0.25 | 0.3 |
| Fragrance | 0.3 | 0.3 | — | 0.3 |
| Water | 2.8 | 2.5 | 4.5 | 2.5 |
| | 100.00 | 100.00 | 100.00 | 100.00 |

A pill is manufactured by compressing the below formula with a compression of 1200 kg/cm² (diameter 13.0 mm; height 8 mm; weight 1.4 g).

| Component | Wt % |
|---|---|
| Lactose | 20.0 |
| Microcrystaline cellulose | 18.0 |
| Sodium bicarbonate | 31.0 |
| Citric Acid | 16.0 |
| Protease | 8.0 |
| Phosphonate | 2.0 |
| Polyethyleneglycol | 4.0 |
| Mg Stearate | 0.5 |
| dye | 0.5 |
| | 100.0 |

The pill is added to the cavity and adhered thereto by means of an adhesive (either molten sorbitol or molten PEG 6000).

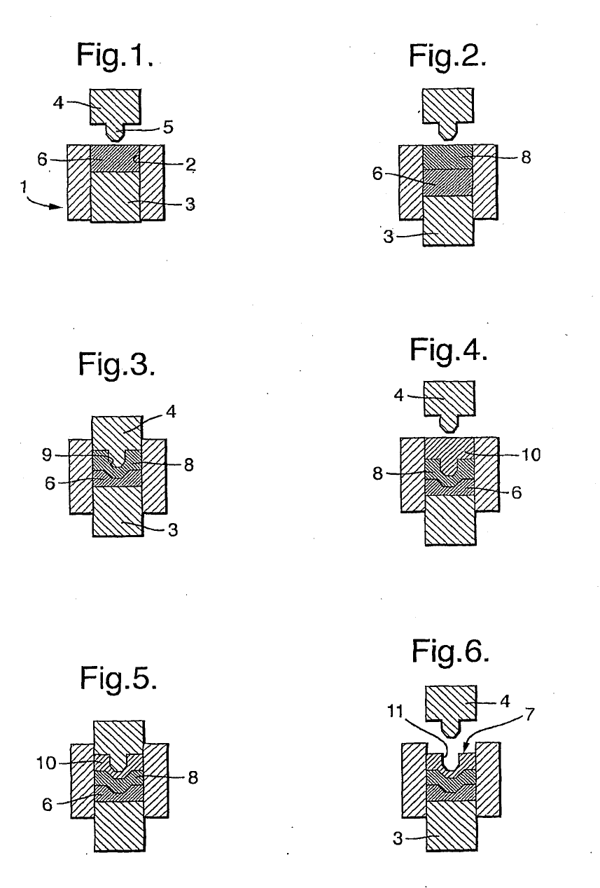

The invention will now be further illustrated with reference to FIGS. 1 to 6.

FIGS. 1 to 6 (all side views) show stages of a tablet forming method of the present invention.

The tablet forming apparatus 1 (shown schematically) comprises a body having a chamber 2 which co-operates with a lower piston 3 and an upper piston 4. The lower piston 3 is planar and the upper piston 4 has a central projection 5. Both pistons 3 and 4 are movable relative to the chamber 2. The chamber 2 is rectangular.

In operation the composition for a first layer 6 of a tablet 7 is added to the chamber 2. The lower piston 3 is then moved relative to the chamber 2 creating a vacant space in the chamber 2. The space is then filled with a composition for a second layer 8 of the tablet 7.

The first layer 6 and the second layer 8 are then compressed at a relatively low compression pressure by the upper piston 4. In this intermediate stage, due to the central projection 5 on the upper piston 4, the second layer 8 has a recess 9 on its upper surface. A central portion of the second layer 8 projects into a recess in the first layer 6 (formed in the compression stage).

The composition for a third layer 10 of a tablet 7 is then added to the chamber 2. The two layers 6, 8 and 9 are then compressed at a relatively high compression pressure by the upper piston 4. Similar to the second layer 8, the third layer 10 has a recess 11 on its upper surface. A central portion of the third layer 10 projects into the recess 9 in the second layer 8.

Subsequently (not shown) a pill may be added to the recess 11 and glued therein.

It would also be conceivable to produce a multi-layer tablet with more than 3 layers.

It is obvious for someone skilled in the art that there are more and other embodiments of the article of the pre-sent application achieving the basic feature of the invention.

The features disclosed in the foregoing description, in the claims and/or drawings may, both separately and in any combination thereof be material for realising the invention in diverse forms thereof.

1. A process for making a tablet having at least three layers, the process comprising the steps of:
a) adding a first composition into a mould of a tabletting press;
b) adding a second composition into the mould of the tabletting press;
c) compressing the first two compositions with a piston, said piston having a projection on its compressing surface;
d) adding a third composition into the mould of the tabletting press;
e) compressing the third composition with the piston, and
f) optionally adding a further composition into the recess of the tablet.

2. A process according to claim 1, wherein steps (d) and/or (e) are repeated to obtain a tablet having more than three layers.

3. A process according to claim 1, wherein the depth of the recess is up to 65% of the overall height of the tablet.

4. A process according to claim 1, wherein the compression pressure in step (c) is lower than in step (e).

5. A process according to claim 4, wherein the compression pressure in step (c) is about 200 kg/cm².

6. A process according to claim 4, wherein the compression pressure in step (e) is about 700-900 kg/cm².

7. A process according to claim 1, wherein the compositions of each of the layers is particulate in nature.

8. A process according to claim 7, wherein the particulates have a particle size of between 100 μm and 2000 μm.

9. A process according to claim 1, wherein the layers are sized such that each layer comprises at least 20% of the overall volume of the tablet.

10. A process according to claim 1, wherein the layers each comprises about 30-40% of the volume of the tablet.

11. A process according to claim 1, wherein the composition which is optionally present in the recess in an upper face of the tablet comprises a pre-formed shape or may be added in a fluid form.

12. A process according to claim 1, wherein the tablets are adapted for use in a domestic cleaning process.

13. An automatic washing operation comprising the use of a tablet according to claim 1 in said automatic washing operation.

14. A process according to claim 8 wherein the particulates have a particle size of between 600 μm and 1000 μm.

15. A process according to claim 1 wherein the layers are sized such that each later comprises at least 20% of the overall height of the tablet.

16. A process according to claim 11 wherein the composition is in the form of a flowing particulate.

17. A process according to claim 11 wherein the composition is in the form of a liquid.

18. A process according to claim 12 wherein the tablets are adapted for use in an automatic washing operation.

19. A process according to claim 12 wherein the tablets are adapted for use in an automatic dishwashing operation.

20. A tablet having at least three discrete layers formed by a process comprising the steps of:
a) adding a first composition into a mould of a tabletting press;
b) adding a second composition into the mould of the tabletting press;
c) compressing the first two compositions with a piston, said piston having a projection on its compressing surface;
d) adding a third composition into the mould of the tabletting press;
e) compressing compression the third composition with the piston, and
f) optionally adding a further composition into the recess of the tablet.
